(19) United States
(12) Patent Application Publication
(10) Pub. No.: US 2022/0061444 A1
(43) Pub. Date: Mar. 3, 2022

(54) BEANIE WITH INTEGRATED LED HEADLAMP FOR ACCOMODATING A PONYTAIL

(71) Applicant: Jenny Lynn Gibson, Spokane, WA (US)

(72) Inventor: Jenny Lynn Gibson, Spokane, WA (US)

(21) Appl. No.: 17/400,416

(22) Filed: Aug. 12, 2021

Related U.S. Application Data
(60) Provisional application No. 63/069,750, filed on Aug. 25, 2020.

(51) Int. Cl. A42B 1/244; F21V 21/084

(52) U.S. Cl. CPC A42B 1/244; F21V 21/084

(57) ABSTRACT

A beanie is provided. The beanie includes a cap portion configured to fit the head of a user. The cap portion includes a first opening. The first opening is configured to enable a ponytail of the user to extend through. The beanie further includes a headlamp unit that is removably mounted to the cap portion.

### CROSS-REFERENCE TO RELATED APPLICATIONS

This application claims benefit under 35 U.S.C. § 119(e) of Provisional Application No. 63/069,750 filed Aug. 25, 2020, the disclosure of which is incorporated by reference in its entirety.

### FIELD

This application relates to a beanie with integrated LED headlamp for accommodating a ponytail.

### BACKGROUND

Wearer with ponytails generally find wearing a beanie to be uncomfortable. This discomfort is further increased after adding a headlamp, especially for outdoor activities. For example, the beanie usually doesn't cover the down over your ears, but this action causes the beaning to move out of the optimal position. In addition, if you then try to put a headlamp on over the top of your beanie, which is in turn on top of your ponytail, pressure that is uncomfortable to the wearer is applied to the head from the strap that runs along the center and rides on top of the area of the beanie where the ponytail is crammed into. If the wearer moves the strap to one side or the other side, the adjustments on the headlamp still need to be tightened to keep it on the head, which also at the same time adds pressure to the ponytail. The straps of the headlamp may only be tighten so much. If they are tighten too much, it may cause a headache to the wear. In general, it is an uncomfortable combination to deal with, especially when the wearer is doing any type of physical activity. Wearing the hair down just to accommodate a beanie and headlamp is not practical or really comfortable either, since the hair is now flopping around getting in the way.

### SUMMARY

In one aspect of the present invention, a beanie is provided. The beanie includes a cap portion configured to fit the head of a user. The cap portion includes a first opening. The first opening is configured to enable a ponytail of the user to extend through. The beanie further includes a headlamp unit that is removably mounted to the cap portion.

Other aspects of the disclosed beanie with integrated LED headlamp for accommodating a ponytail will become apparent from the following detailed description, the accompanying drawings and the appended claims.

### BRIEF DESCRIPTION OF THE DRAWINGS

FIG. 1 is a perspective view of the beanie with integrated LED headlamp for accommodating a ponytail being worn on a head of a wearer according to an embodiment of the invention;

FIG. 2 is a top and rear perspective view of the beanie of FIG. 1;

FIG. 3 is a front perspective view of the beanie of FIG. 1;

FIG. 4 is a front perspective view of a beanie of FIG. 1 with the front edge folded up to show the inner side of the LED headlamp unit;

FIG. 5 is a front view of the retainer with stitching openings and the LED headlamp unit;

FIG. 6 is a side view of the LED headlamp unit mounted in the retainer;

FIG. 7 is a front view of the LED headlamp unit mounted in the retainer;

FIG. 8 is a side view of the retainer;

FIG. 9 is a rear view of the LED headlamp unit mounted in the retainer;

FIG. 10 is a front view of the retainer and the LED headlamp unit separated from each other;

FIG. 11 is a front view of the cap of the beanie with the LED headlamp unit and the retainer removed for illustrative purposes; and

FIG. 12 is a front and side perspective view of the LED headlamp unit and retainer with the LED headlamp unit being pushed out of the retainer.

### DETAILED DESCRIPTION

It will be readily understood that the components of the embodiments as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, etc. In other instances, well-known structures, materials, or operations are not shown or described in detail to avoid obfuscation. The following description is intended only by way of example, and simply illustrates certain example embodiments.

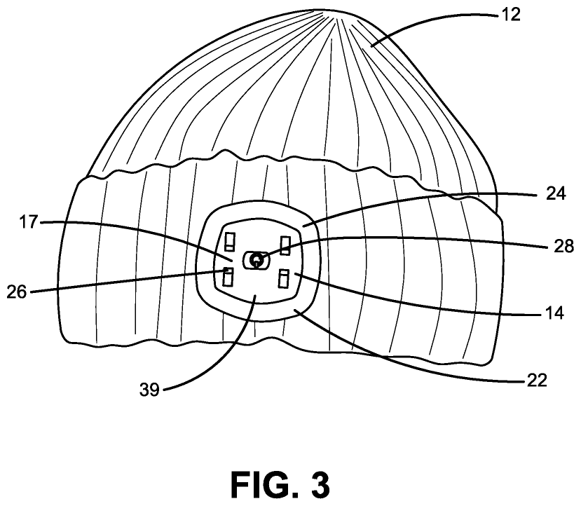

Throughout the present description, the terms “upper”, “lower”, “top”, “bottom”, “left”, “right”, “front”, “forward”, “rear”, and “rearward” shall define directions or orientations with respect to the beanie as illustrated in FIG. 3. It will be understood that the spatially relative terms “upper”, “lower”, “top”, “bottom”, “left”, “right”, “front”, “forward”, “rear”, and “rearward” are intended to encompass different orientations of the beanie in use or operation in addition to the orientation depicted in the figures. For example, if the beanie in the figures is turned over, elements described as “upper” elements or features would then be “lower” elements or features.

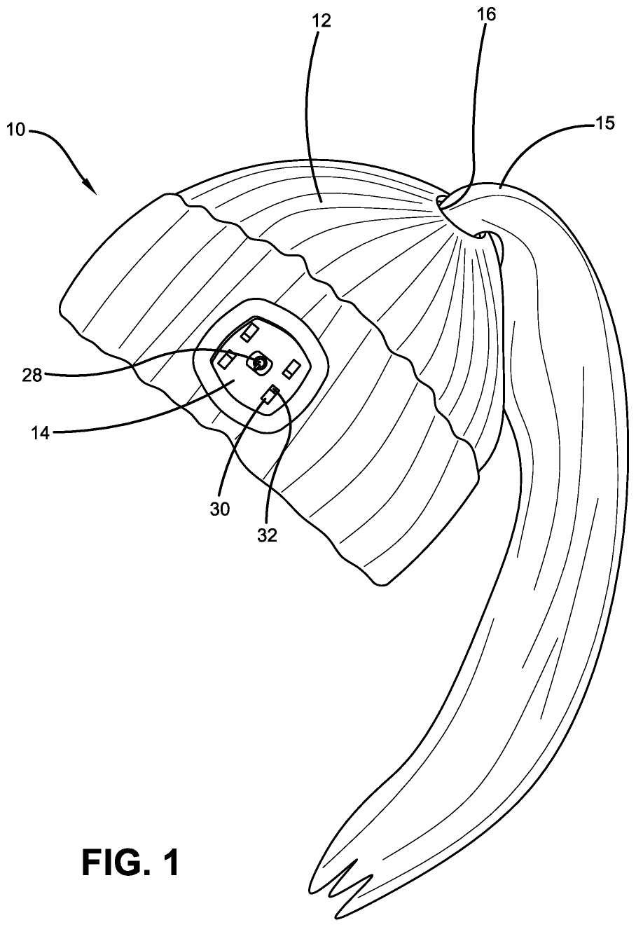

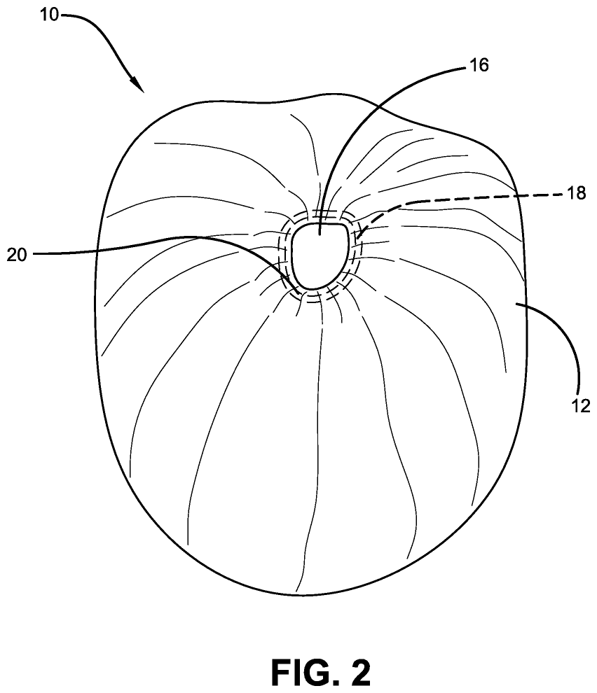

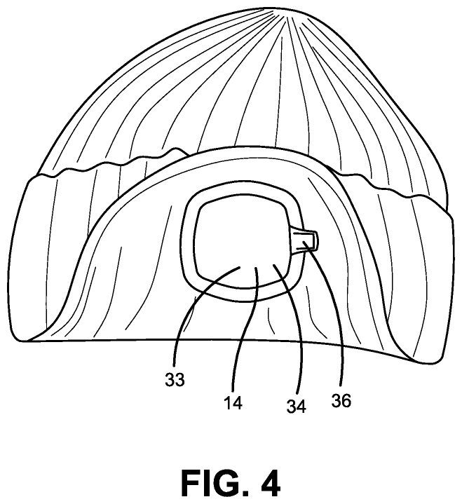

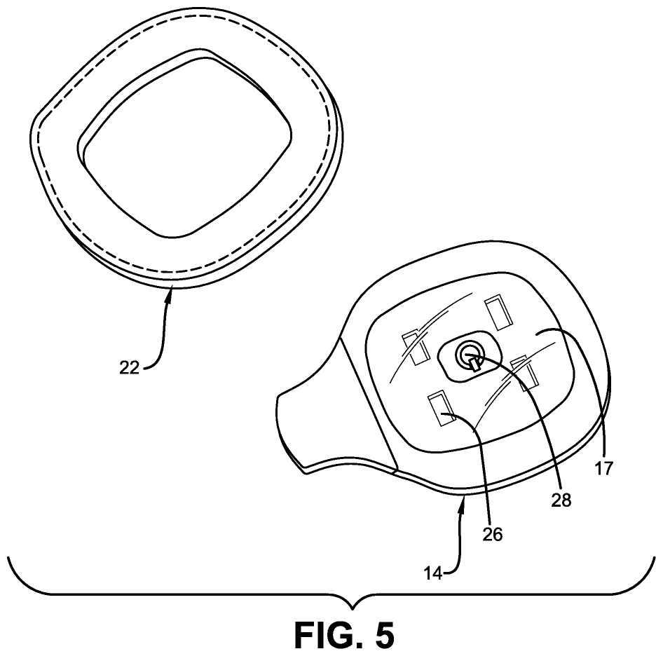

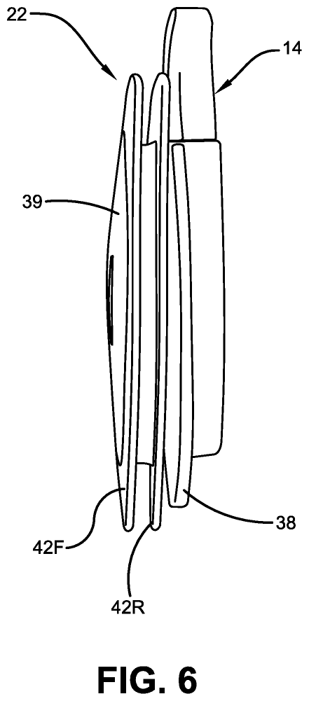

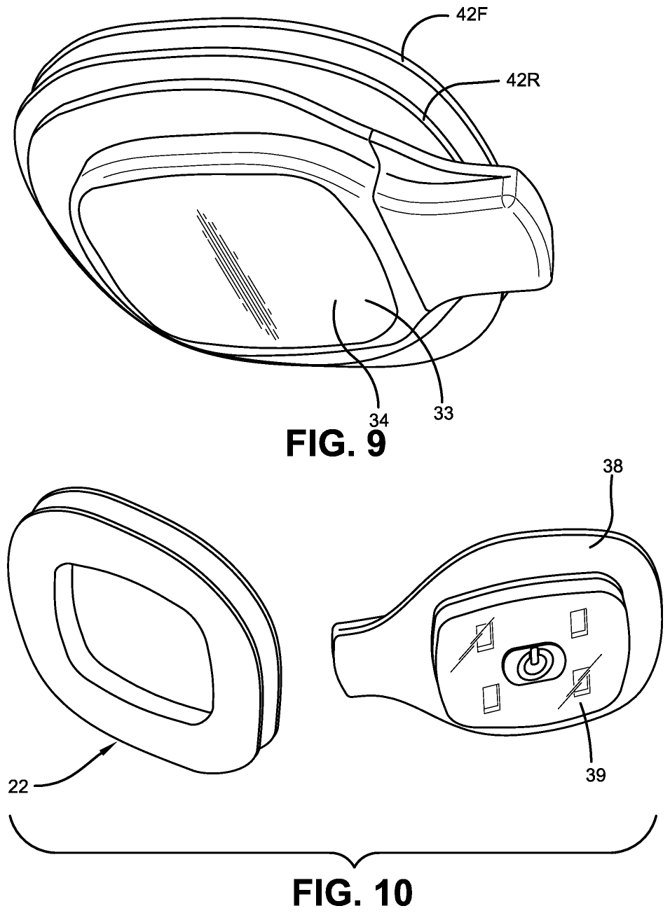

Referring to FIGS. 1 to 4, the beanie 10 comprises cap portion 12, an LED headlamp unit 14 and an opening 16 for the ponytail 15. The cap portion 12 may be made of 100% soft stretchable acrylic knit in various colors and patterns to accommodate variance in head size and shape. As illustrated in FIG. 2, the opening 16 is defined by an elastic band 18 (FIG. 2) sewn into the beanie 10. The elastic band 18 is also secured to the beanie 10 by reinforced stitching 20 (FIG. 2) that matches the color of the beanie 10. The opening 16 is located near the top of the beanie 10. As illustrated in FIGS. 3 and 5, the front side 17 of the LED headlamp unit 14 includes four LED lights 26 housed in a front translucent housing 39 that surrounds a power push button 28. Each light 26 includes one half section 30 that emits a yellow colored light and another half section 32 that emits a white colored light as illustrated in FIG. 1. As depicted in FIGS. 4 and 9, the rear side 33 of the LED headlamp unit 14 includes a battery compartment 34 and charging port 36 for charging the battery in the LED headlamp unit 14. A rear lamp flange 38 is located rearwardly adjacent the front housing 39 as seen in FIGS. 6 and 10.

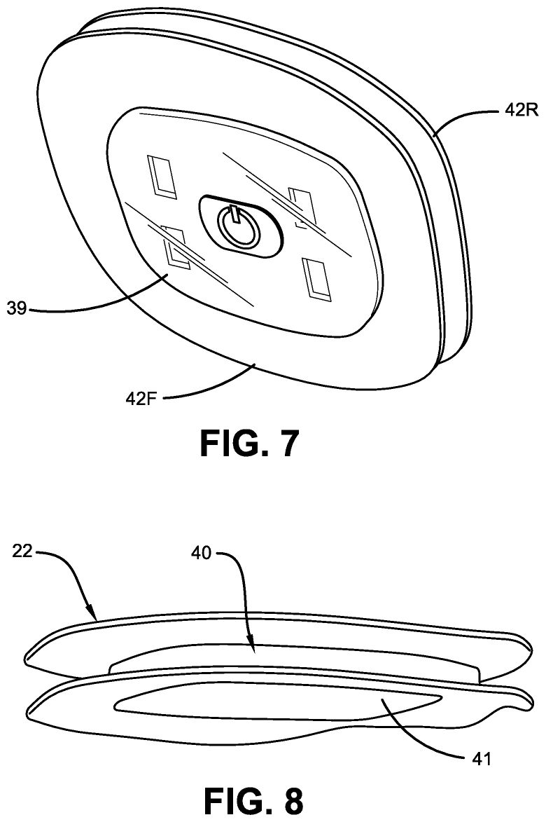

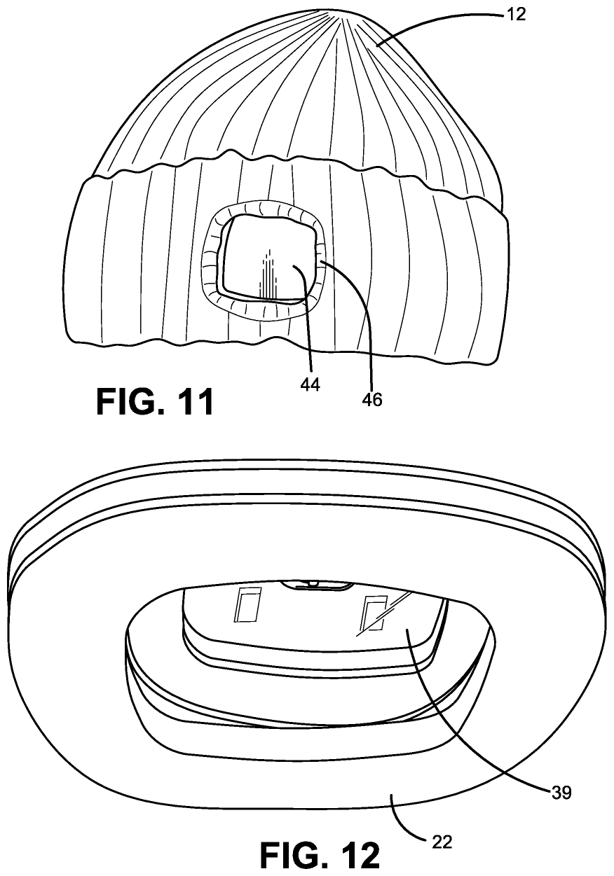

As illustrated in FIG. 3, the LED headlamp unit 14 is removably mounted to an elastic ring-shaped retainer 22. The retainer 22 is glued and sewn or stitched to the beanie 10. The retainer 22 may be made of any suitable elastic but resilient type of material such as natural or synthetic rubber or plastic. As seen in FIGS. 6, 7, 8 and 10, the retainer 22 includes a hub member 40 (FIG. 8). Front and rear retainer flanges 42F, 42R (FIG. 9) are attached to the hub member 40 and radially extend outwardly from the hub member 40. The hub opening 41 (FIG. 8) defined by the hub member 40 is aligned with a front opening 44 (FIG. 11) of the beanie 10 when the retainer 22 is attached to the beanie 10. The mounting end portion 46 (FIG. 11) of the beanie that defines the front opening 44 is sandwiched between the front and rear retainer flanges 42F, 42R and glued to the front and rear retainer flanges 42F, 42R. In addition, the front and rear retainer flanges 42F, 42R and the mounting end portion 46 are stitched or sewn together for additional securement of the retainer 22 to the beanie 10. The front housing 39 of the LED lamp unit 14 is sized to be press fitted into the hub opening 41 to removably mount the LED headlamp unit 14 to the retainer 22.

The LED headlamp unit 14 may be removably mounted to the retainer 22, so that the LED headlamp unit 14 may be removed from the beanie 10 to charge the batteries in the LED headlamp unit 14 or to wash the beanie 10. In particular, to mount the LED headlamp unit 14 to the retainer 22, a user grasps the rear lamp flange 38 and inserts the front housing 39 into the hub opening 41 defined by the hub member 40 until the rear lamp flange 38 engages the rear retainer flange 42R. The hub opening 41 and the front housing 39 are constructed and arrange so that the hub member 40 engages the front housing 39 to removably secure the front housing 39 to hub member 40. The hub opening 41 and the front housing 39 have a non-circular shape such as a square with rounded corners to prevent the rotation of the front housing 39 in the hub opening 41. The hub member 40 may include a rear lip that receives a rear annular groove formed around the side of the front housing 39 for additional securement of the front housing 39 to the retainer 22. The four lights 26 and power push button 28 face forwardly and outwardly through the hub opening 41 of the retainer 22 when the LED headlamp unit 14 is mounted to the retainer 22 as seen in FIG. 3. To remove the LED headlamp unit 14, the user may push rearwardly against the front housing 39 to disengage the front housing 39 from the hub opening 41 and push out the LED headlamp unit 14 as illustrated in FIG. 12.

The LED headlamp unit 14 can be charge through its charging port 36. The charging port 36 may be a USB port. The area on the front of the beanie 10 where the LED lights are located has reinforced stitching that will match the color of the beanie 10 to handle being taken out and re-inserted numerous times for washing over the beanies lifetime.

The beanie 10 with integrated rechargeable LED headlamp unit 14 is to be worn over the head and ears to allow the ponytail to protrude through the elastic lined opening 16 located near the top of the beanie 10. At any given time if light is desired, the user may simply push the power button 28 located on the LED headlamp unit 14 to turn on the LED lights 26. With the light on, the user can continue the activity without having to stop and grab a stand alone headlamp, put it on, and/or have to adjust the headlamp to be comfortable over his or her ponytail and then resume the activity. When finished using the light, the user can press the power button 28 on the head lamp unit 14 until it shuts off. There may be more than one lighting option on the head lamp unit 14. For example, just one or two or three lights might be able to be turned or just the yellow colored or white colored lights might be turned on, or combinations of those options.

These elements make a ponytail friendly beanie with integrated headlamp a fully functional, comfortable, well made, stylish and an affordable product for active women or men who wear ponytails. The type of ponytail friendly beanie could be different in type of fabric used, shape of beanie, or style of beanie. The LED head lamp unit could be changed to a different shape and/or function differently, but still be combined in the same fashion and perform and function as previously mentioned. The beanie according to the present invention is comfortable to wear and allows for hands free lighting and while providing the functional purpose of wearing a beanie to cover all the parts that need to be covered all in one product. The beanie may be offered in a larger selection of colors and patterns for women or men.

This invention provides a solution to the above-mentioned problem by having a headlamp built into the beanie and having an opening in the beanie for the ponytail to pass through. Wearers will not feel the strap from the headlamp that normally runs right over the top of the ponytail which is very uncomfortable. Further, the wearer will not have to stop in the middle of his or her activity to adjust the straps on the headlamp to prevent them from shifting around or continue to pull the beanie over your ears because it keeps sliding up. The present invention eliminates straps, pressure, adjusting, tugging and pulling, and increases comfort, and functionality better than products currently available. This allows the wearer to focus on the activity and not on how uncomfortable all of the gear is.

Although various embodiments of the disclosed beanie with integrated LED headlamp for accommodating a ponytail have been shown and described, modifications may occur to those skilled in the art upon reading the specification. The present application includes such modifications and is limited only by the scope of the claims.

What is claimed is:

1. A beanie comprising:
a cap portion configured to fit the head of a user, wherein the cap portion includes a first opening, wherein the first opening is configured to enable a ponytail of the user to extend through; and
a headlamp unit, wherein the head lamp unit is removably mounted to the cap portion.

2. The beanie of claim 1 further comprising a retainer, wherein the retainer is attached to the cap portion, wherein the head lamp unit is removably mounted to the retainer.

3. The beanie of claim 2, wherein the retainer comprising a hub member and first and second retainer flanges extending radially outward from the hub member, wherein the cap portion includes a mounting end portion that defines a second opening, wherein hub member is aligned with the second opening, wherein the mounting end portion is sandwiched between the first and second retainer flanges and secured to the retainer.

4. The beanie of claim 3, wherein the hub member defines a hub opening, wherein headlamp unit includes a housing, wherein the housing houses one or more lights, wherein the housing is removably press fitted into the hub opening.

5. The beanie of claim 4, further comprising an elastic band, wherein the elastic band defines the first opening.

6. The beanie of claim 5, wherein the elastic band is secured to the beanie by reinforced stitching.

7. The beanie of claim 1, further comprising an elastic band, wherein the elastic band defines the first opening.

8. The beanie of claim 7, wherein the elastic band is secured to the beanie by reinforced stitching.

9. The beanie of claim 1, wherein the headlamp unit includes at least one light, wherein the light includes a first portion that emits a first colored light, wherein the light includes a second portion that emits a second colored light that is of different color than the first colored light.

10. The beanie of claim 1, wherein the headlamp unit includes a charging port for charging a battery in the headlamp unit.
